(19) United States
(12) Patent Application Publication
(10) Pub. No.: US 2016/0239885 A1
(43) Pub. Date: Aug. 18, 2016

(54) Method of Making and Managing Online Purchases from Different External Vendors

(71) Applicant: Kenneth Goolsby, College Station, TX (US)

(72) Inventor: Kenneth Goolsby, College Station, TX (US)

(21) Appl. No.: 15/046,429

(22) Filed: Feb. 17, 2016

Related U.S. Application Data
(60) Provisional application No. 62/117,073, filed on Feb. 17, 2015.

(51) Int. Cl. G06Q 30/06

(52) U.S. Cl. CPC G06Q 30/0605; G06Q 30/0619; G06Q 30/0635; G06Q 30/0641

(57) ABSTRACT

A method of making and managing online purchases from different external vendors helps users shop online across a plurality of external vendor websites. Users are able to track and manage purchases through a single user interface. When a user adds a physical product to a virtual cart, a potential purchase notification and product information is visually extracted from the desired website. Product information is displayed on the single user interface, which prompts the user account to purchase physical products. The method involves a plurality of user accounts capable of accessing external vendor websites hosted on a network of remote servers. The user account is able to communicate with multiple proxy accounts. Each proxy account is used to manage purchase requests for a single external vendor website. The proxy accounts allow savings to be passed to users and eliminates the need for users to directly interact with each external vendor website.

The current application claims a priority to the U.S. Provisional Patent application Ser. No. 62/117,073 filed on Feb. 17, 2015.

### FIELD OF THE INVENTION

The present invention generally relates to a commerce system process. More specifically, the present invention is method of making online purchases with a plurality of external vendor websites through a single user interface.

### BACKGROUND OF THE INVENTION

Most internet vendors allow customers to shop for items they would like to purchase, store those items in a virtual “cart” and “checkout,” or pay for the items in the cart when the customer is ready to pay and have those items delivered. The problem with this model is that it is proprietary, unique, and hard linked to each site. Customers cannot transfer information, like purchase history, from one site to another site seamlessly. Further, in order to achieve the most amount of savings from online purchases, customers likely need to shop with different vendors. In the evolution of the online shopping experience, customers need a universal, ubiquitous, and more convenient way to checkout or pay for the items that they accumulate in a shopping cart.

Accordingly, the present invention allows customers to shop from site to site, accumulate items, and when they are ready to checkout, they can do so with one system. The customer authorizes payment and shipping when they are ready to do so. The present invention works on the customer's behalf to make purchases across a plurality of external vendor websites. The present invention involves the use of a single user interface, eliminating the need for customers to remember countless usernames and passwords for various vendor accounts. Further, customers are not required to set up sensitive payment information with numerous vendors.

### BRIEF DESCRIPTION OF THE DRAWINGS

FIG. 1 is a system diagram of the present invention.

FIG. 2 is a flowchart describing the general process of the present invention.

FIG. 3 is a flowchart describing the step of sending a product hold request when a potential purchase notification is received.

FIG. 4 is a flowchart describing the steps of displaying a product suggestion.

FIG. 5 is a flowchart describing the steps of displaying a product suggestion based on a savings threshold.

FIG. 6 is a flowchart describing the steps of sending a purchase request to an external vendor website through a proxy account.

FIG. 7 is a flowchart describing the steps of using the proxy account to negotiate a new price for a combined order request.

FIG. 8 is a flowchart describing the steps of separating an order payment to pay for multiple purchase requests.

FIG. 9 is a flowchart describing the steps logging purchase requests in a transaction history.

FIG. 10 is a flowchart describing the steps of incrementing a rewards counter for a purchase request.

FIG. 11 is a flowchart describing the steps of extracting product information through a visual recognition process.

FIG. 12 is a flowchart describing the steps of displaying an out-of-stock notification.

FIG. 13 is a flowchart describing the steps of displaying an in-stock notification.

FIG. 14 is a flowchart describing the steps of displaying a limited stock notification.

### DETAILED DESCRIPTION OF THE INVENTION

All illustrations of the drawings are for the purpose of describing selected versions of the present invention and are not intended to limit the scope of the present invention.

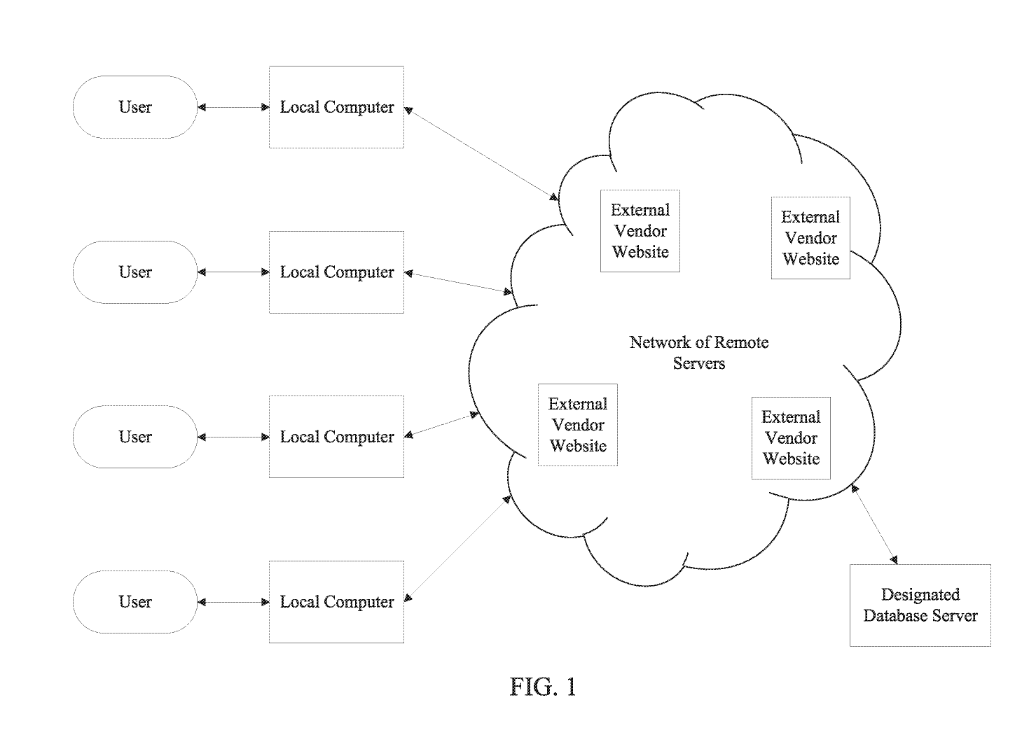

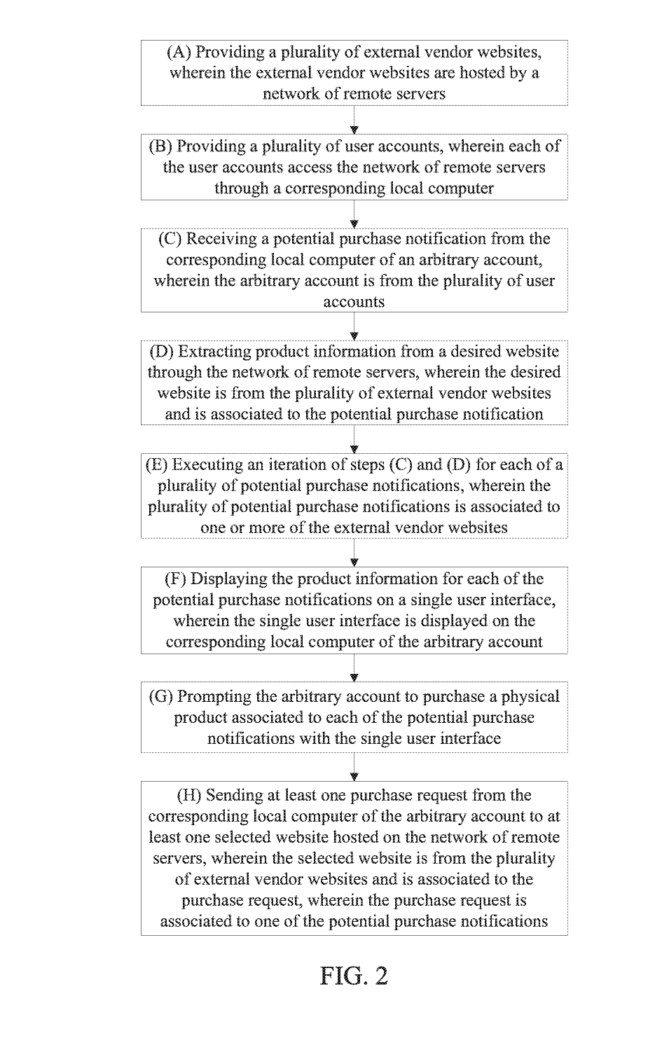

With reference to FIGS. 1-2, the present invention is a method of making and managing online purchases from different external vendors. In the preferred embodiment of the present invention, the method relies on a system comprising a plurality of external vendor websites which are hosted by a network of remote servers (Step A). The plurality of external vendor websites is used to display physical products, their original prices, and other information related to those physical products to help guide users through an online shopping experience. The network of remote servers is used to handle traffic to the external vendor websites and manage information regarding products and transactions. The plurality of external vendor websites and the network of remote servers used to host the external vendor websites operate independently from the present invention. However, the method of the present invention involves interacting with the plurality of external vendor websites in order to provide an improved online shopping experience. The system of the preferred embodiment further comprises a plurality of user accounts which access the network of remote servers through a corresponding local computer (Step B). The plurality of user accounts is used to manage user information, payment information, and purchase history.

In reference to FIG. 2, the method of the present invention simplifies and organizes the process of making multiple online purchases with various vendors. When a user selects a physical product to be purchased, a potential purchase notification is received from the corresponding local computer of an arbitrary account (Step C). The arbitrary account can be any account from the plurality of user accounts. The potential product notification equates to the user putting an item into a virtual shopping cart. When the potential product notification is received, product information is extracted from a desired website through the network of remote servers (Step D). The desired website is from the plurality of external vendor websites and is associated to the potential purchase notification. The product information is compiled and displayed for the user, allowing the user to review the physical products they are about to purchase without revisiting any of the external vendor websites. The product information can include, but is not limited to, the original price of the physical product, photos of the physical product, and specifications for the physical product. An iteration of steps C and D is executed for each of a plurality of potential purchase notifications (Step E). Users may repeat steps C and D for each physical product that they intend to purchase. The product information for each of the potential purchase notifications is displayed on the corresponding local computer of an arbitrary account (Step F). This allows users to review each of the potential product notifications before purchasing. The arbitrary account is prompted to purchase a physical product associated to each of the potential purchase notifications with the single user interface (Step G). This allows the user to select which purchases will be made through the system. If a potential purchase notification is not selected, the potential purchase notification may either be removed or held onto for a future purchase. Depending on the number of potential purchase notifications selected, at least one purchase request is sent from the corresponding local computer of the arbitrary account to at least one selected website hosted on the network of remote servers (Step H). The selected website is from the plurality of external vendor websites and is associated to the purchase request. Because purchase requests may be for varying external vendor websites, each purchase request is associated to one of the potential purchase notifications and is configured to be automatically registered with each selected website without the need for further interaction from the user.

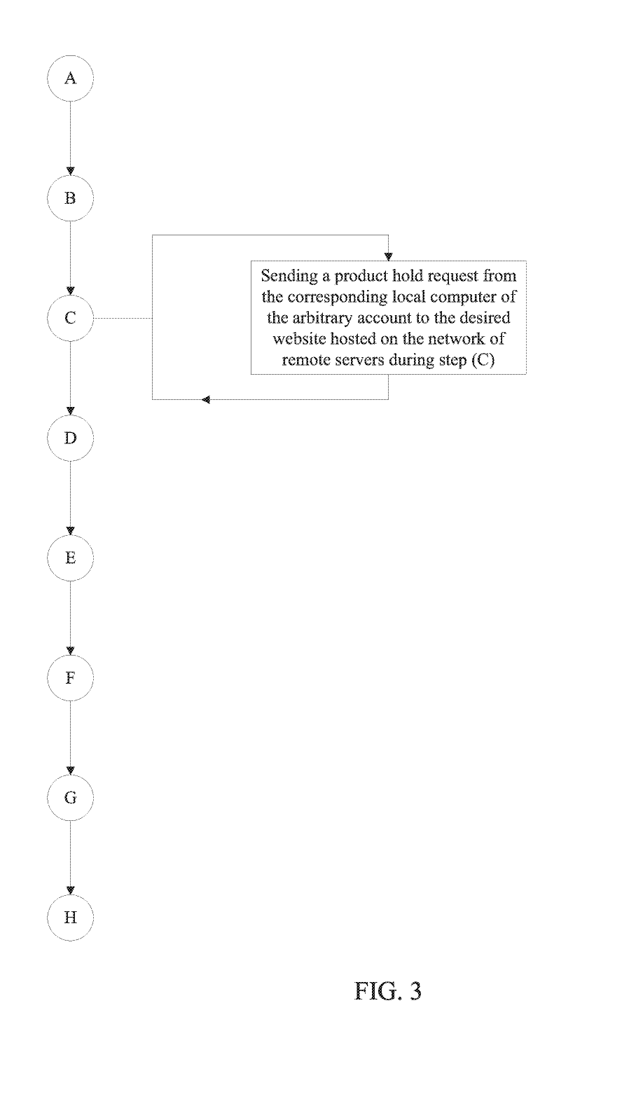

As can be seen in FIG. 3, when a potential purchase notification is received, the present invention may request that the desired website hold the physical product so that the user is guaranteed that the physical product will not sell out. To do so, a product hold request is sent from the corresponding computer of the arbitrary account to the desired website hosted on the network of remote servers during step C. This feature ultimately depends on the terms of each individual external vendor website. Accordingly, the amount of time in which a physical product is kept on hold can vary between external vendor websites.

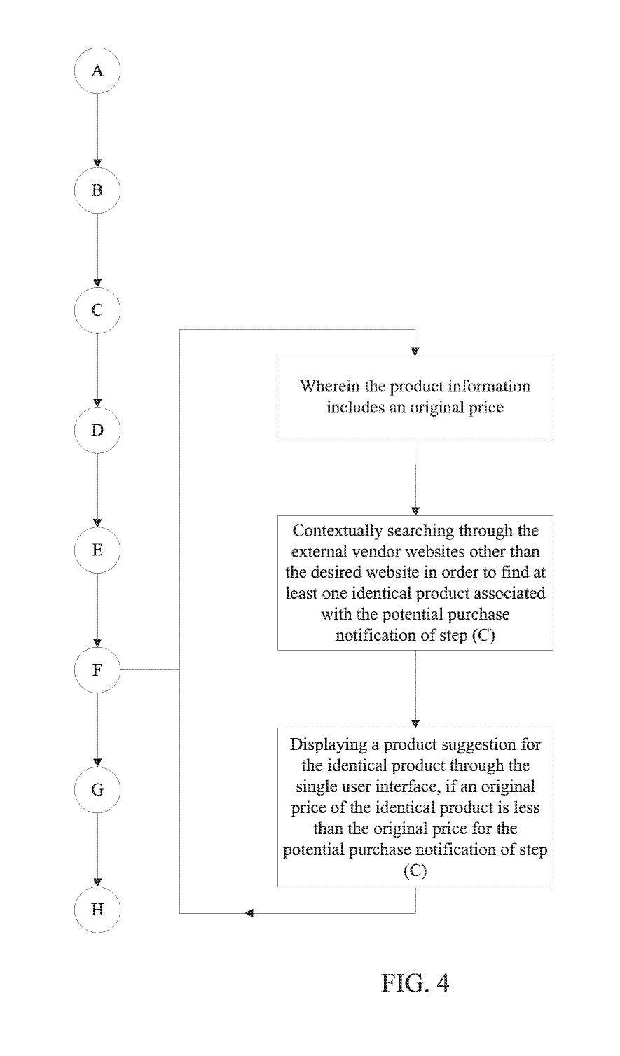

In the preferred embodiment of the present invention, the system may be used to help users find better prices for physical products. In reference to FIG. 4, the product information that is extracted from the desired website includes an original price. The original price represents the price in which the external vendor website is willing to sell a physical product for and may not be the best price available to the user. To ensure that the user is presented with the best possible price, the external vendor websites other than the desired website are contextually searched in order to find at least one identical product associated with the potential purchase notification of step C. The search process can be done with information such as, but not limited to, the product name, the product shop keeping unit (SKU), and product brand. While the preferred embodiment of the present invention searches for an exact match for the physical product associated to the potential purchase notification, various features may be ignored on the search based on user preference. Such features can include, but are not limited to the color of the product and the name of the product. A product suggestion is displayed for the identical product through the single user interface, if an original price of the identical product is less than the original price for the potential purchase notification of step C. This allows the user to find potential savings on external vendor websites other than the desired website, without having to browse through identical products which cost the same or more than the original price of the physical product associated to the potential purchase notification.

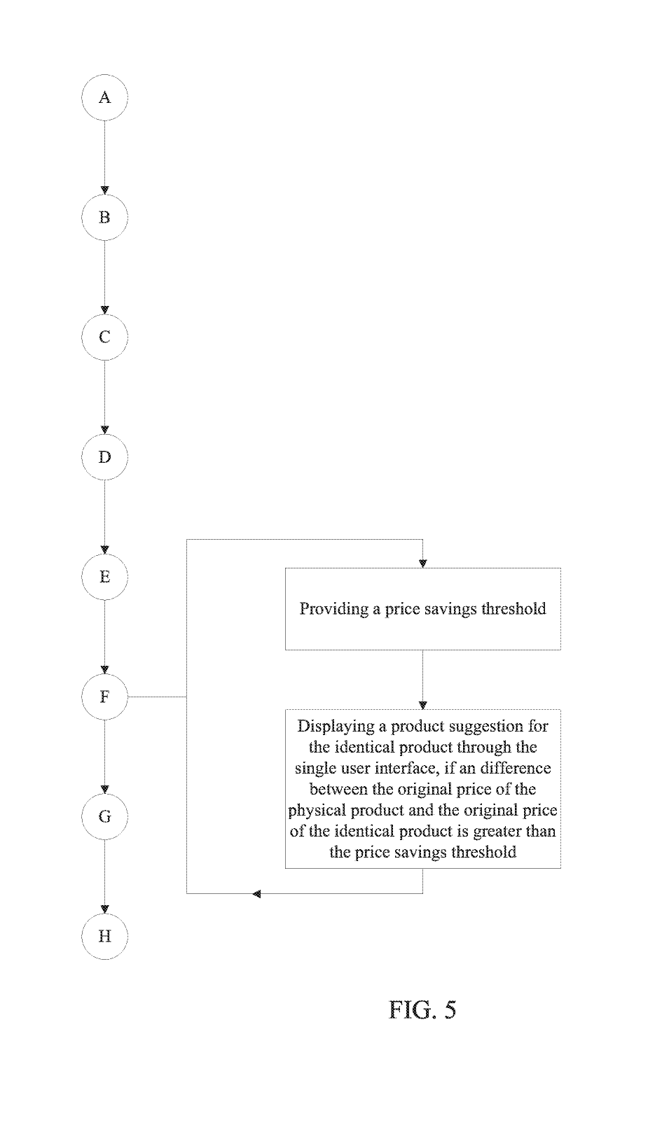

Depending on the user's preference, a price savings threshold may be provided. In reference to FIG. 5, the price savings threshold allows the user to control the circumstances which permit a product suggestion to be displayed. The product suggestion for the identical product is only displayed through the single user interface if a difference between the original price of the physical product and the original price of the identical product is greater than the price savings threshold. By using the price savings threshold, the user is able to ignore product suggestions for identical products that do not offer a significant amount of savings.

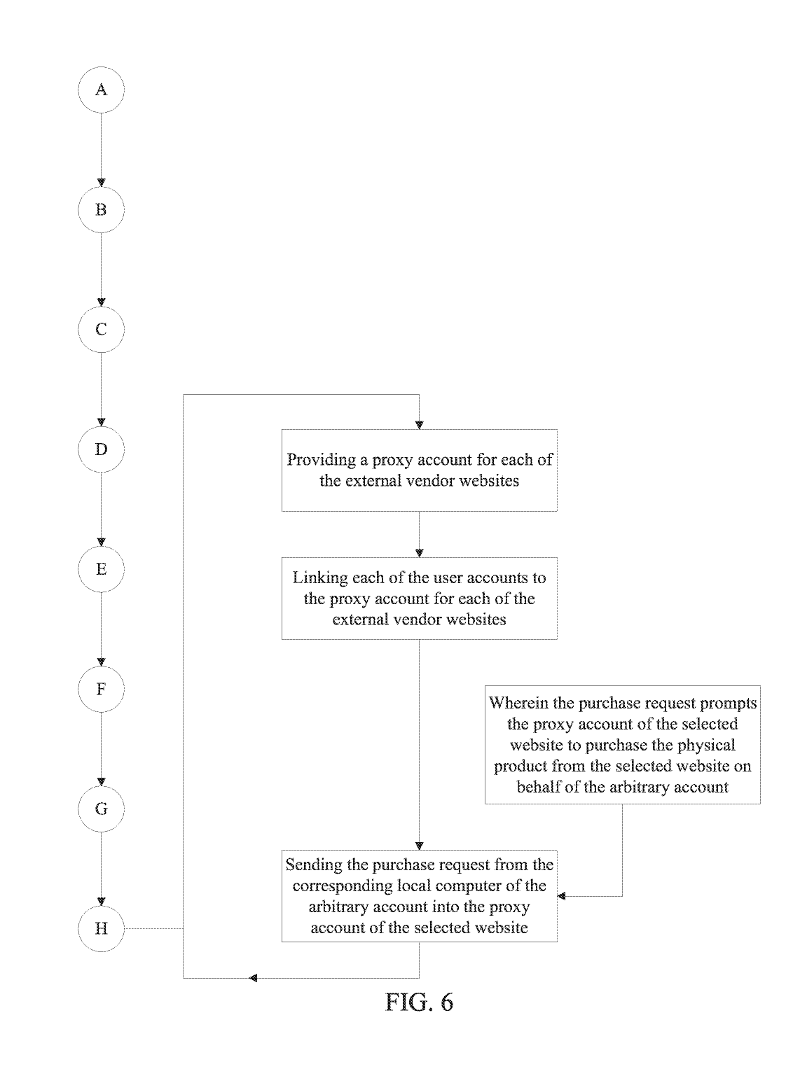

In reference to FIG. 6, the present invention may also be used to save users money by negotiating with vendors. Often, external vendor websites offer savings for orders which exceed a minimum purchase amount. The present invention may be used to represent a number of users such that orders are bundled together and the savings may be passed to the user. To do this, a proxy account is provided for each of the external vendor websites. Each of the user accounts is linked to the proxy account for each of the external vendor websites so that the proxy account can be used to manage purchase requests for the plurality of user accounts. The purchase request is sent from the corresponding local computer of the arbitrary account into the proxy account of the selected website. The purchase request prompts the proxy account of the selected website to purchase the physical product from the selected website on behalf of the arbitrary account so that the user is not required to register or login to any of the external vendor websites.

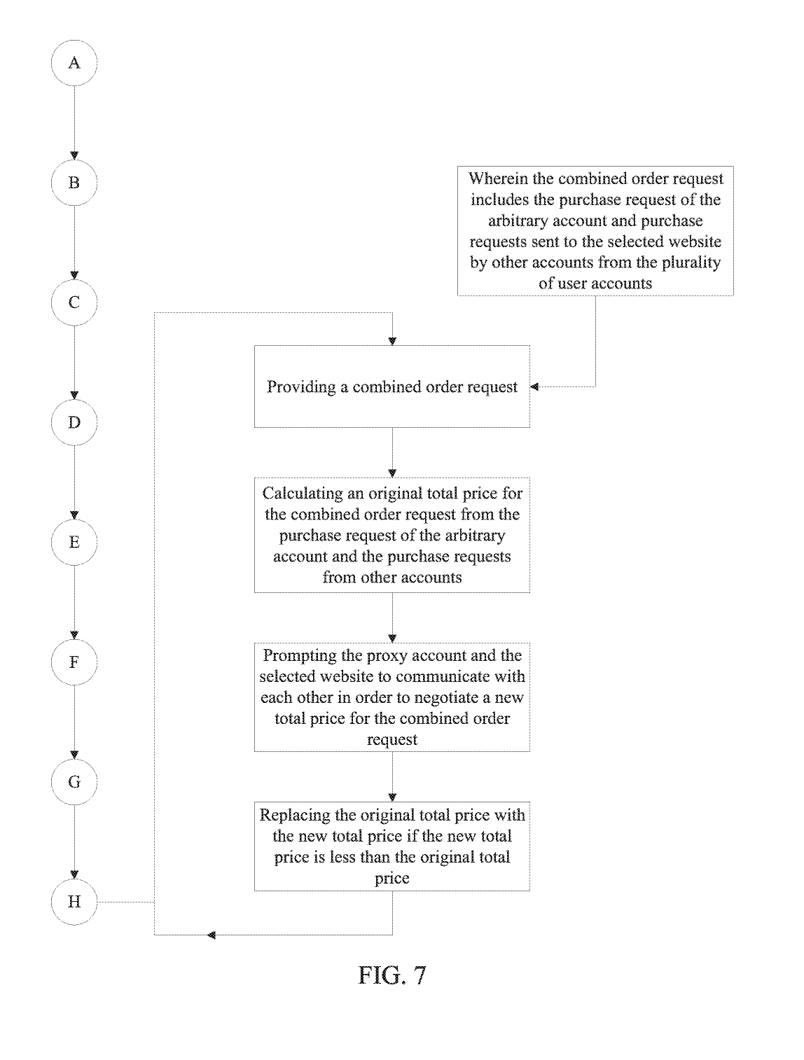

In order for proxy accounts to represent a number of users, a combined order request is provided. In reference to FIG. 7, the combined order request includes the purchase request of the arbitrary account and the purchase requests sent to the selected website by other accounts from the plurality of user accounts. Because vendors often provide savings on orders and shipping when orders are placed in bulk or exceed a minimum price, using combined order requests help users to more easily achieve savings. An original total price is calculated for the combined order request from the purchase request of the arbitrary account and the purchase requests from the other accounts. The proxy account and the selected website are prompted to communicate with each other in order to negotiate a new total price for the combined order request. This is done to maximize the amount of savings which are ultimately passed down to each individual user. The original total price is replaced with the new total price, if the new total price is less than the original total price. Otherwise, no changes are made. The end result in terms of how much money each user saves may be calculated based on how much each user spends, or may be spread equally amongst each of the users involved in a given order.

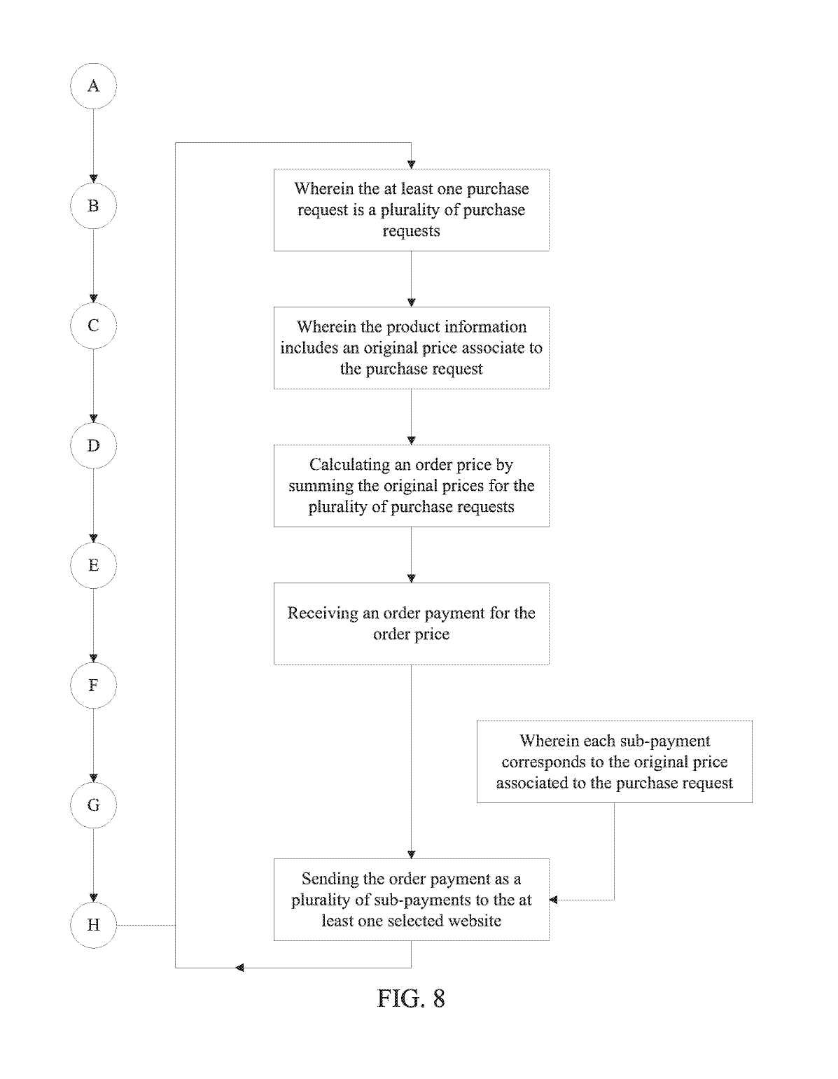

Under the circumstances where the at least one purchase request is a plurality of purchase requests, the method of the present invention may be used to direct payments to each external vendor website. To do this, the original price, associated to each purchase request, is used to determine how much a user must pay, and how payments are divided amongst the external vendor websites. In reference to FIG. 8, an order price is calculated by summing the original prices for the plurality of purchase requests. The order price represents the total amount of money the user needs to pay for the physical products they wish to purchase. An order payment is received for the order price through the corresponding local computer. The order payment may be made using a credit card, an online payment system, or through other suitable means. The order payment is sent as a plurality of sub-payments to the at least one selected website. Each sub-payment corresponds to the original price associated to the purchase request. If the user purchases multiple physical products from a single external vendor website, the sub-payments sent to that external vendor website may be grouped to streamline the process.

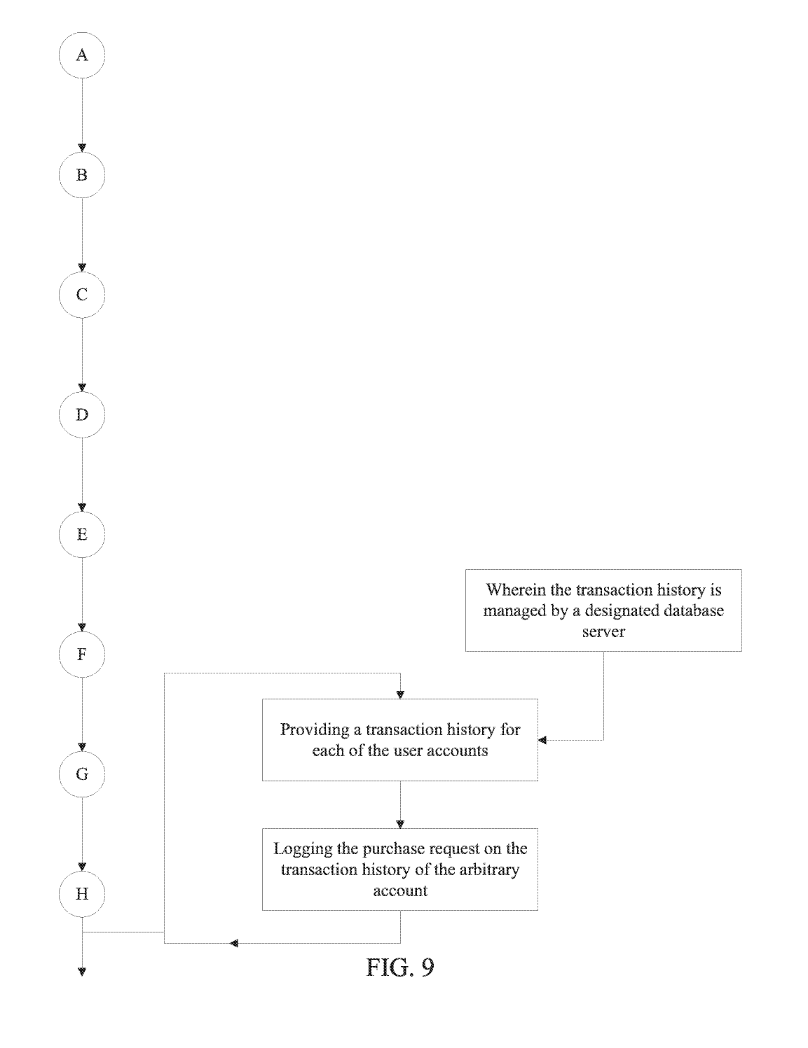

As can be seen in FIG. 9, in the preferred embodiment of the present invention, a transaction history is provided for each of the user accounts and is managed by a designated database server. The transaction history may be used for coordinating refunds or replacements, and can also contain shipping information. The purchase request is logged on the transaction history of the arbitrary account. This allows users to see all of their purchases across plurality of external vendor websites in one location.

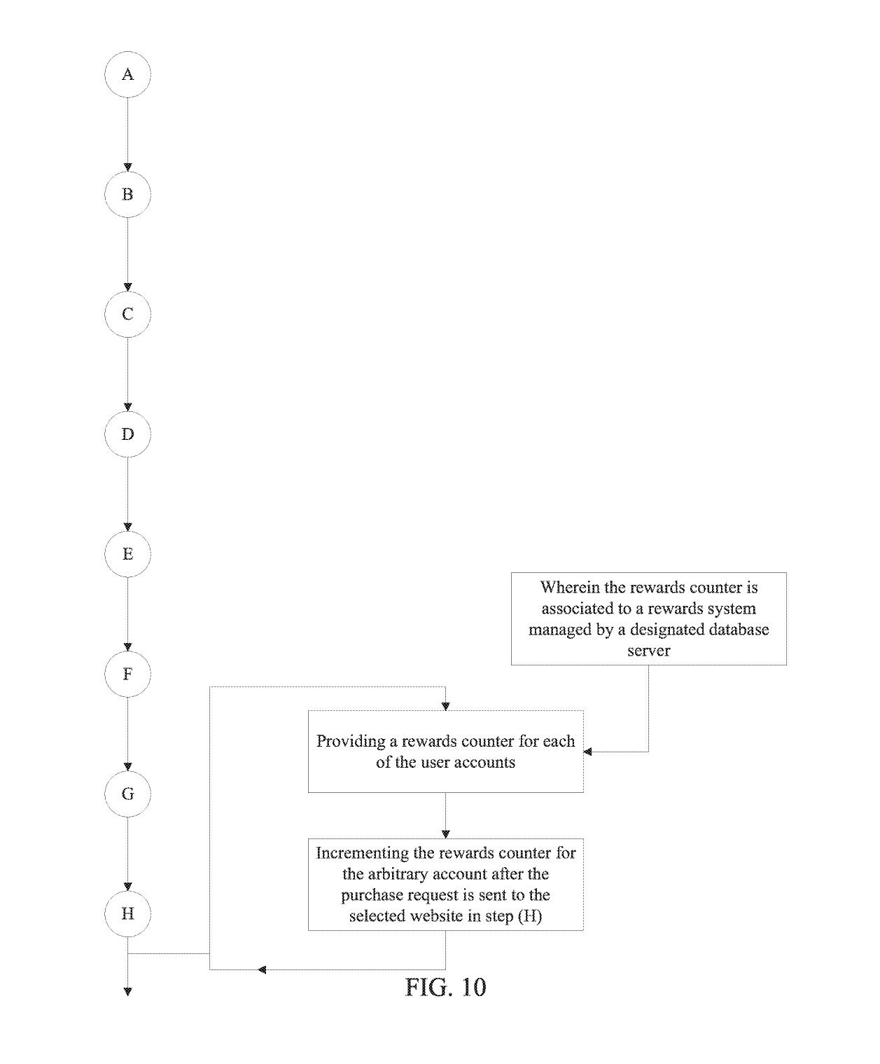

In the preferred embodiment of the present invention, the system further comprises a rewards counter for each of the user accounts. In reference to FIG. 10, the rewards counter is managed by the designated database server and is associated to a rewards system managed by the network of remote servers. The rewards system allows users to earn money, reward points, or some other form of repayment for using the present invention. The rewards counter is incremented for the arbitrary account after the purchase request is sent to the selected website in step H. Although users shop across a plurality of external vendor websites, the rewards system can be used to reimburse users, regardless of which external vendor websites are used to purchase physical products.

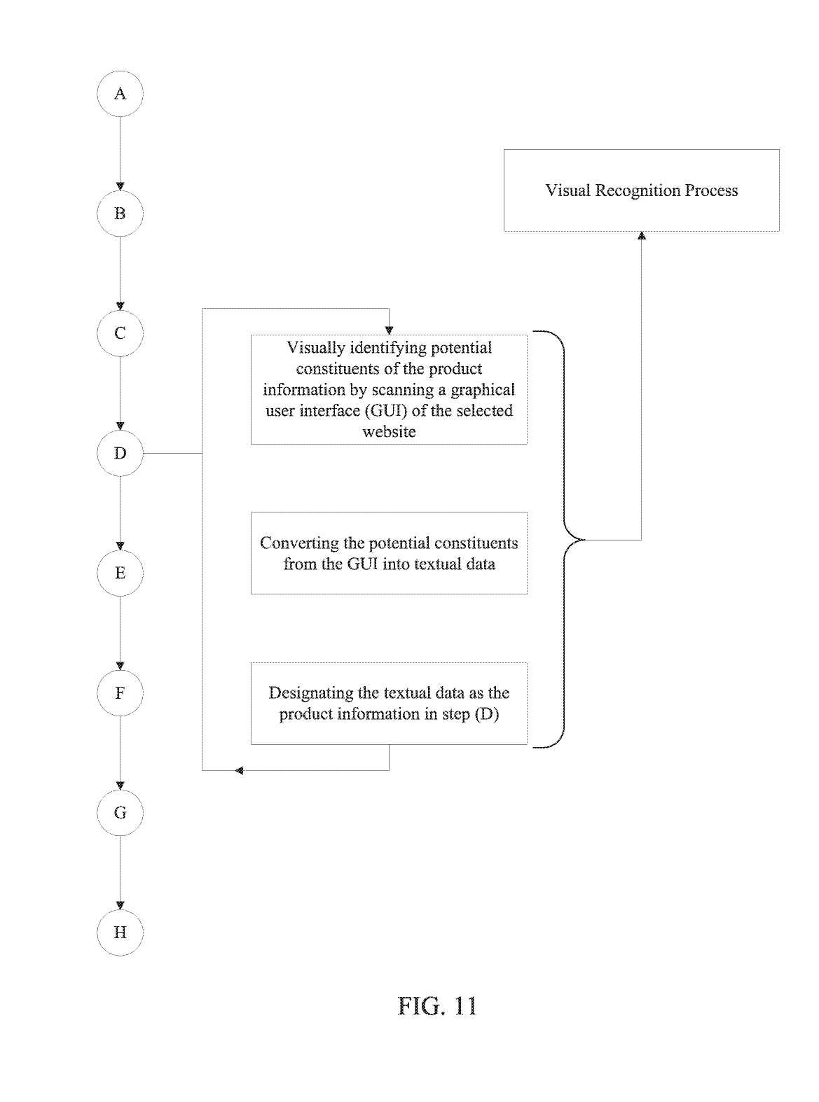

In the preferred embodiment of the present invention, product information is extracted in step D through a visual recognition process. As can be seen in FIG. 11, in the visual recognition process, potential constituents of the product information are visually identified by scanning a graphical user interface (GUI) of the selected website. The potential constituents represent areas of the GUI for each external vendor website which may contain text that is included with the potential information. This can include pricing information, shipping information, the stock amount for the physical product, and various other pieces of information. The potential constituents from the GUI are converted into textual data. This is done because textual data may be more easily formatted than the images of each potential constituent. The textual data is designated as the product information in step D and may be organized for the user before being displayed by the single user interface. This process is beneficial because it does not require that every bit of information about an external vendor website be analyzed. Only relevant information is visually identified and included as the product information.

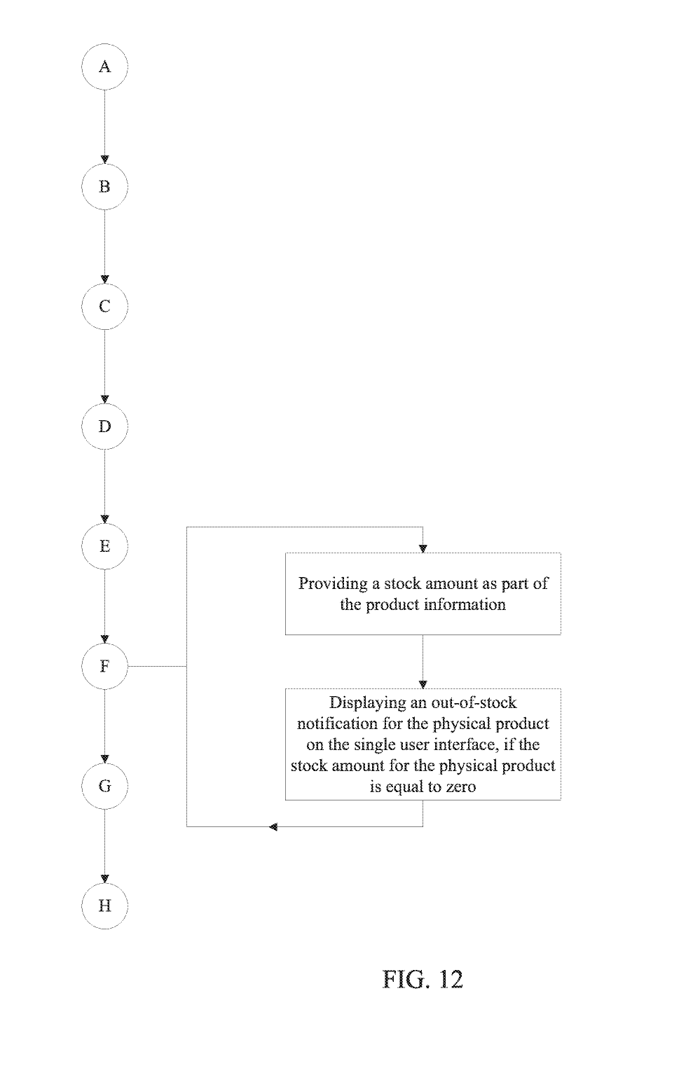

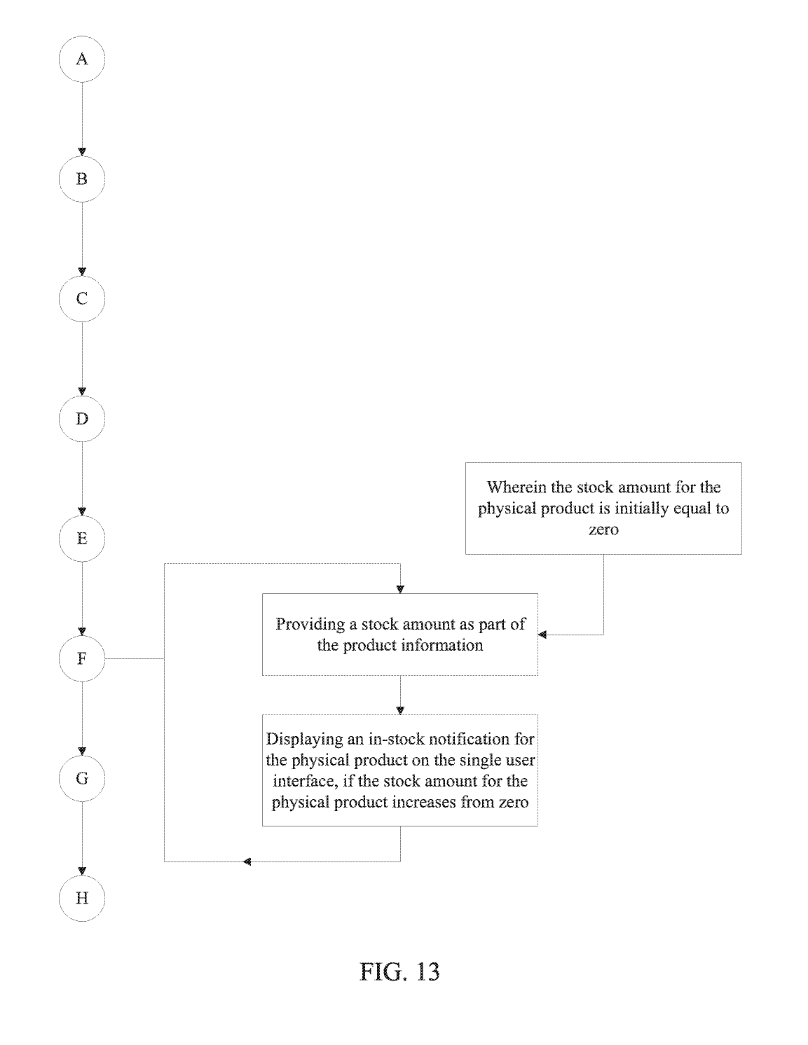

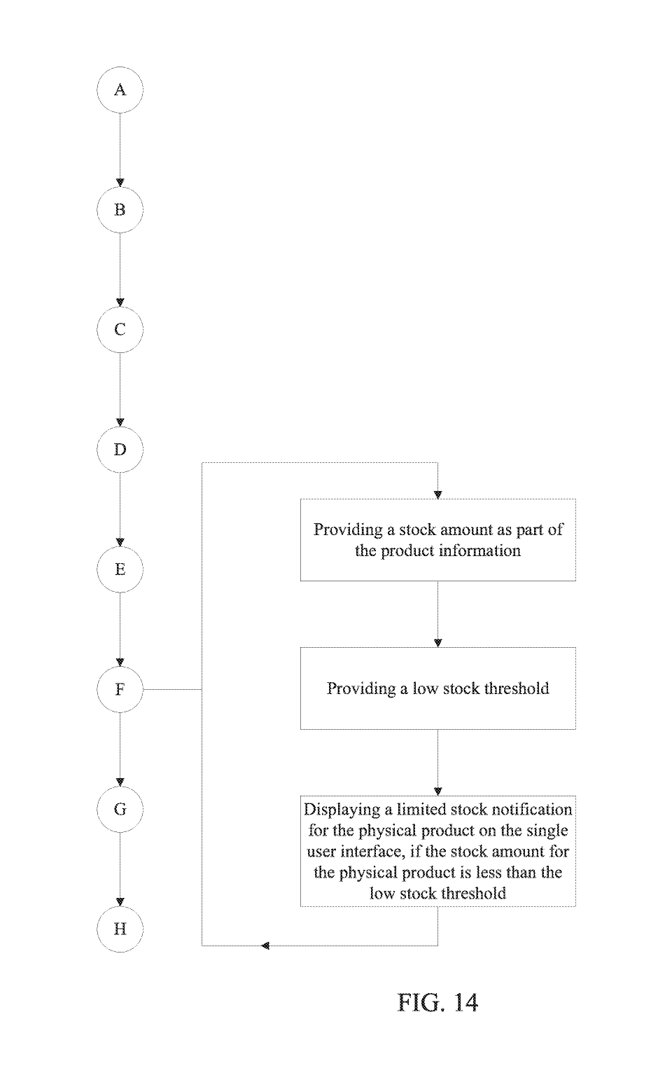

In the preferred embodiment of the present invention, a stock amount is provided as part of the product information. The stock amount is used to track how many physical products the external vendor website is able to sell. In reference to FIG. 12, an out-of-stock notification for the physical product is displayed on the single user interface, if the stock amount for the physical product is equal to zero. This lets the user know that a purchase request cannot be made until the stock amount increases. Ultimately, the user may choose to search other external vendor websites or wait until physical products are restocked. If a potential purchase notification is received for a physical product that is out of stock, the user may also be notified when vendors restock products. In reference to FIG. 13, an in-stock notification for the physical product is displayed on the single user interface, if the stock amount for the physical product increases from zero. This allows the user to be notified immediately when a physical product is available, reducing the chance that the user misses out on buying the physical product again. In the preferred embodiment of the present invention, a low stock threshold is also used for sending notifications to the user. In reference to FIG. 14, a limited stock notification for the physical product is displayed on the single user interface, if the stock amount for the physical product is less than the low stock threshold. This is done to alert users that a physical product will soon sell out, notifying users to purchase physical products before it is too late.

Although the invention has been explained in relation to its preferred embodiment, it is to be understood that many other possible modifications and variations can be made without departing from the spirit and scope of the invention as hereinafter claimed.

What is claimed is:

1. A method of making and managing online purchases from different external vendors, the method comprises the steps of:
(A) providing a plurality of external vendor websites, wherein the external vendor websites are hosted by a network of remote servers;
(B) providing a plurality of user accounts, wherein each of the user accounts access the network of remote servers through a corresponding local computer;
(C) receiving a potential purchase notification from the corresponding local computer of an arbitrary account, wherein the arbitrary account is from the plurality of user accounts;
(D) extracting product information from a desired website through the network of remote servers, wherein the desired website is from the plurality of external vendor websites and is associated to the potential purchase notification;
(E) executing an iteration of steps (C) and (D) for each of a plurality of potential purchase notifications, wherein the plurality of potential purchase notifications is associated to one or more of the external vendor websites;
(F) displaying the product information for each of the potential purchase notifications on a single user interface, wherein the single user interface is displayed on the corresponding local computer of the arbitrary account;
(G) prompting the arbitrary account to purchase a physical product associated to each of the potential purchase notifications with the single user interface; and
(H) sending at least one purchase request from the corresponding local computer of the arbitrary account to at least one selected website hosted on the network of remote servers, wherein the selected website is from the plurality of external vendor websites and is associated to the purchase request, wherein the purchase request is associated to one of the potential purchase notifications.

2. The method of making and managing online purchases from different external vendors claimed in claim 1 comprises the step of:
sending a product hold request from the corresponding local computer of the arbitrary account to the desired website hosted on the network of remote servers during step (C).

3. The method of making and managing online purchases from different external vendors as claimed in claim 1 comprises the steps of:
wherein the product information includes an original price;
contextually searching through the external vendor websites other than the desired website in order to find at least one identical product associated with the potential purchase notification of step (C); and
displaying a product suggestion for the identical product through the single user interface,
if an original price of the identical product is less than the original price for the potential purchase notification of step (C).

4. The method of making and managing online purchases from different external vendors as claimed in claim 3 comprises the steps of:
providing a price savings threshold; and
displaying a product suggestion for the identical product through the single user interface,
if a difference between the original price of the physical product and the original price of the identical product is greater than the price savings threshold.

5. The method of making and managing online purchases from different external vendors as claimed in claim 1 comprises the steps of:
providing a proxy account for each of external vendor websites;
linking each of the user accounts to the proxy account for each of the external vendor websites; and
sending the purchase request from the corresponding local computer of the arbitrary account into the proxy account of the selected website, wherein the purchase request prompts the proxy account of the selected website to purchase the physical product from the selected website on behalf of the arbitrary account.

6. The method of making and managing online purchases from different external vendors as claimed in claim 5 comprises the steps of:
providing a combined order request, wherein the combined order request includes the purchase request of the arbitrary account and purchase requests sent to the selected website by other accounts from the plurality of user accounts;
calculating an original total price for the combined order request from the purchase request of the arbitrary account and the purchase requests from the other accounts;
prompting the proxy account and the selected website to communicate with each other in order to negotiate a new total price for the combined order request; and
replacing the original total price with the new total price,
if the new total price is less than the original total price.

7. The method of method of making and managing online purchases from different external vendors as claimed in claim 5 comprises the steps of:
wherein the at least one purchase request is a plurality of purchase requests;
wherein the product information includes an original price associated to the purchase request;
calculating an order price by summing the original prices for the plurality of purchase requests;
receiving an order payment for the order price; and
sending the order payment as a plurality of sub-payments to the at least one selected website, wherein each sub-payment corresponds to the original price associated to the purchase request.

8. The method of making and managing online purchases from different external vendors as claimed in claim 1 comprises the steps of:
providing a transaction history for each of the user accounts, wherein the transaction history is managed by a designated database server; and
logging the purchase request on the transaction history of the arbitrary account.

9. The method of making and managing online purchases from different external vendors as claimed in claim 1 comprises the steps of:
providing a rewards counter for each of the user accounts, wherein is associated to a rewards system managed by a designated database server; and
incrementing the rewards counter for the arbitrary account after the purchase request is sent to the selected website in step (H);

10. The method of making and managing online purchases from different external vendors as claimed in claim 1, wherein the product information is extracted in step (D) through a visual recognition process.

11. The method of making and managing online purchases from different external vendors as claimed in claim 9 comprises the steps of:
visually identifying potential constituents of the product information by scanning a graphical user interface (GUI) of the selected website;
converting the potential constituents from the GUI into textual data; and
designating the textual data as the product information in step (D).

12. The method of making and managing online purchases from different external vendors as claimed in claim 1 comprises the steps of:
providing a stock amount as part of the product information; and
displaying an out-of-stock notification for the physical product on the single user interface,
if the stock amount for the physical product is equal to zero.

13. The method of making and managing online purchases from different external vendors as claimed in claim 1 comprises the steps of:
providing a stock amount as part of the product information, wherein the stock amount for the physical product is initially equal to zero;
displaying an in-stock notification for the physical product on the single user interface,
if the stock amount for the physical product increases from zero;

14. The method of making and managing online purchases from different external vendors, the method as claimed in claim 1 comprises the steps of:
providing a stock amount as part of the product information;
providing a low stock threshold; and
displaying a limited stock notification for the physical product on the single user interface,
if the stock amount for the physical product is less than the low stock threshold.
